(19) United States
(12) Patent Application Publication
(10) Pub. No.: US 2015/0262253 A1
(43) Pub. Date: Sep. 17, 2015

(54) METHOD AND APPARATUS FOR SELECTING AUCTION BIDS

(71) Applicant: Ashok Banerjee, Fremont, CA (US)

(72) Inventor: Ashok Banerjee, Fremont, CA (US)

(73) Assignee: GOOGLE INC., Mountain View, CA (US)

(21) Appl. No.: 12/138,011

(22) Filed: Jun. 12, 2008

(51) Int. Cl. G06Q 30/02

(52) U.S. Cl. CPC G06Q 30/0275

(57) ABSTRACT

One embodiment of the present invention provides a system that facilitates selecting auction bids. During operation, the system receives a collection of bids, wherein each bid in the collection includes advertised performance criteria. For each bid in the collection, the system analyzes a past performance history for a bidder associated with the bid. Next, for each bid, the system determines an expected performance criteria based on the analyzed past performance history, and the advertised performance criteria. Finally, the system selects a winning bid from the collection of bids based on the expected performance criteria.

### BACKGROUND

1. Field of the Invention

The present invention relates to auction systems. More specifically, the present invention relates to a method and an apparatus for selecting auction bids based on advertised bid rates and observed auction results.

2. Related Art

Organizations are increasingly using auctions to determine which end-providers to contract with to process their transactions. Although using auctions typically helps these organizations control costs, they often have some problems that can result in poor customer service, which can ultimately be more expensive for the organization in the long run.

For example, many auction systems typically take the end-provider's bid as an absolute bid. In many instances, the bid of the end-provider (especially in inter-company bids) may be overly optimistic and unrealistic. In these instances, the bid is only the best estimate based on probabilities as seen by the bidder.

Some auction systems attempt to avoid this problem by using recent performance observations instead of the end-provider's bid. However, such systems can punish the end-provider unnecessarily. For example, the end-provider may have recently increased processing capacity, or may do so when selected by the auction system as the winning bidder.

Hence, what is needed is a method and an apparatus for selecting auction bids without the problems listed above.

### SUMMARY

One embodiment of the present invention provides a system that facilitates selecting auction bids. During operation, the system receives a collection of bids, wherein each bid in the collection includes advertised performance criteria. For each bid in the collection, the system analyzes a past performance history for a bidder associated with the bid. Next, for each bid, the system determines an expected performance criteria based on the analyzed past performance history, and the advertised performance criteria. Finally, the system selects a winning bid from the collection of bids based on the expected performance criteria.

In some embodiments of the present invention, the system analyzes the past performance by computing a mean value of the past performance history. The system also computes a standard deviation of the past performance history.

In some embodiments of the present invention, the system analyzes the past performance by applying an exponential-decay function to the past performance to reduce over time the effect of incidental glitches.

In some embodiments of the present invention, the system determines the expected performance criteria by performing a Monte Carlo simulation which determines performance based on a range of values for the past performance history and the advertised performance criteria.

In some embodiments of the present invention, the system stores the past performance history in a database to facilitate subsequent analysis.

In some embodiments of the present invention, the system generates a graph of the past performance history. The system then stores the graph to facilitate subsequent analysis.

In some embodiments of the present invention, selecting the winning bid can involve selecting a bid with a less desirable mean and a high standard deviation over another bid with a more desirable mean and a low standard deviation.

In some embodiments of the present invention, for a given bid which is associated with a bidder, the system calculates a difference between the past performance history for the bidder and the advertised performance criteria for the bidder for previous bids. The system then uses the difference to weight the bid.

### BRIEF DESCRIPTION OF THE FIGURES

FIG. 1 illustrates a computing environment in accordance with an embodiment of the present invention.

FIG. 2 illustrates an apparatus in accordance with an embodiment of the present invention.

FIG. 3 illustrates an expected performance graph in accordance with an embodiment of the present invention.

FIG. 4 presents a flow chart illustrating the process of selecting bids in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates selecting auction bids. During operation, the system receives a collection of bids, wherein each bid in the collection includes advertised performance criteria. For each bid in the collection, the system analyzes a past performance history for a bidder associated with the bid. Next, for each bid, the system determines an expected performance criteria based on the analyzed past performance history, and the advertised performance criteria. Finally, the system selects a winning bid from the collection of bids based on the expected performance criteria.

For example, in some instances a bidder may be aggressive and submit a bid based on overly optimistic targets. In this example, the likelihood that the bidder can satisfy the advertised performance criteria in their bid is relatively low. If this bidder was selected based on the advertised performance criteria alone, the total cost to the organization accepting the bid might be considerably higher than if the organization were to select other bidders (when the total cost of not meeting the advertised criteria is factored in).

In another example, the system may rely solely on the analysis of past performance history, and not trust the advertised performance criteria if the advertised performance criteria deviates from the past performance history. However, the past performance history may not be indicative of future performance because the bidder may have improved infrastructure, or may improve infrastructure if the bid is accepted.

Embodiments of the present invention take into account both the advertised performance criteria and the past performance history while attempting to determine the expected performance criteria of the bidder.

In some embodiments of the present invention, the system analyzes the past performance by computing a mean value of the past performance history. The system also computes a standard deviation of the past performance history. In many instances, the standard deviation of the past performance history is just as important (if not more so) as the mean value of the past performance history. This is explained in more detail below.

In some embodiments of the present invention, the system analyzes the past performance by applying an exponential-decay function to the past performance to reduce over time an effect of incidental glitches. If a bidder experienced a temporary glitch, such as a temporary network outage, it may be desirable to minimize the effects of the glitch over time. In most cases, the performance surrounding the glitch is not indicative of the future performance of the bidder.

In some embodiments of the present invention, the system determines the expected performance criteria by performing a Monte Carlo simulation based on the past performance history and the advertised performance criteria. Note that the present invention is not meant to be limited to the use of a Monte Carlo simulation. Any similar method or technique for performing statistical analysis and/or sampling may be used with embodiments of the present invention.

In some embodiments of the present invention, the system stores the past performance history in a database to facilitate subsequent analysis.

In some embodiments of the present invention, the system generates a graph of the past performance history. The system then stores the graph to facilitate subsequent analysis. Note that the system may store the entire set of data, a graph of the data, or even an approximate graph of the data to facilitate subsequent analysis. The amount of data stored, the representation of the data stored, and the accuracy of the data stored are implementation decisions.

In some embodiments of the present invention, selecting the winning bid involves selecting a bid with a less desirable mean and a high standard deviation over another bid with a more desirable mean and a low standard deviation.

Consider the example where an organization has a desired performance criterion of 5 seconds for a transaction. Also consider that if the transaction takes longer than 5 seconds, it does not matter how long the transaction takes because it has failed to meet the organization's performance criterion. In this example, the organization receives two bids: the first bid has a mean of 7 seconds, and a standard deviation of +/−1 second; and the second bid has a mean of 9 seconds, and a standard deviation of +/−6 seconds. While the first bid is much closer to the organization's criterion of 5 seconds, and the first bidder is more reliable, the second bid is actually the better choice for the organization.

In this example, the first bidder is reliable, but will also reliably fail the organization's criterion. If the first bid had a mean of 7 seconds, and a standard deviation of +/−1 second, the majority of the transactions for the first bidder will be in the 6 to 8 second range, all of which will fail for the organization. However, if the second bid has a mean of 9 seconds, and a standard deviation of +/−6 seconds, then the majority of the transactions for the second bidder will be in the 3 to 15 second range. Some transactions will be very late; however, some transactions will be in the 3 to 5 second range, and thus, satisfy the organization's criterion. In this case, the second bidder provides an outside chance of success while the first bidder will reliably fail.

In some embodiments of the present invention, for a given bid which is associated with a bidder, the system calculates a difference between the past performance history for the bidder and the advertised performance criteria for the bidder for previous bids. The system then uses the difference to weight the bid. For example, if a particular bidder is very aggressive and always over-commits and under-delivers, then it may be beneficial to use this past difference as a weight to adjust the bidder's current bid.

### Computing Environment

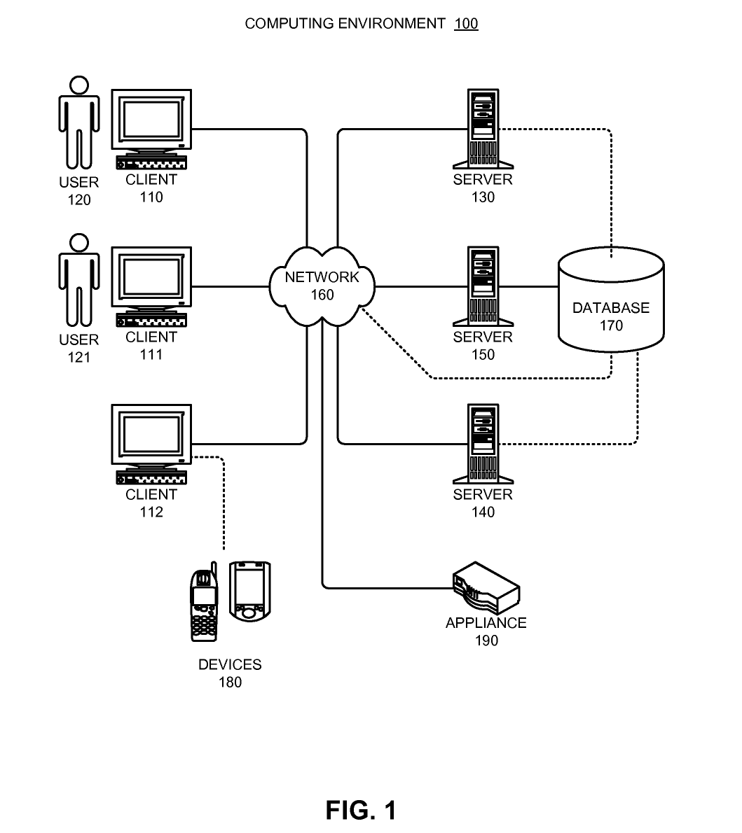

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different configurations, and are not limited to the configuration illustrated in computing environment 100. For example, in some embodiments of the present invention, server 150 may analyze bids from clients 110-112. However, in other embodiments of the present invention, the bids may be analyzed by appliance 190.

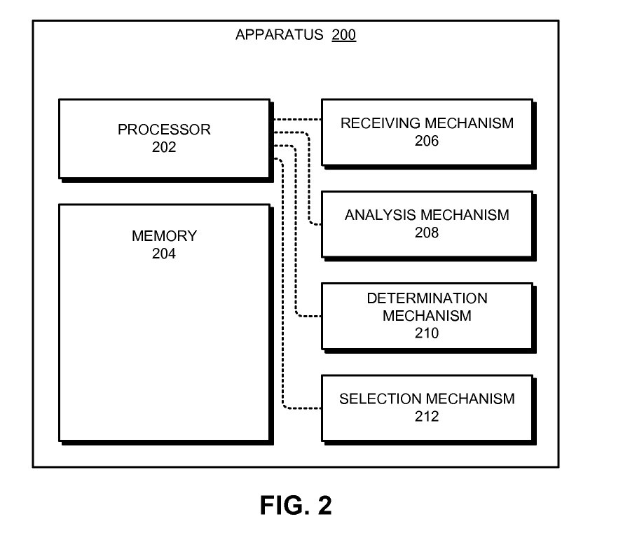

FIG. 2 illustrates apparatus 200 in accordance with an embodiment of the present invention. Apparatus 200 comprises processor 202, memory 204, receiving mechanism 206, analysis mechanism 208, determination mechanism 210, and selection mechanism 212. Note that receiving mechanism 206, analysis mechanism 208, determination mechanism 210, and selection mechanism 212 can be embodied in hardware in apparatus 200, or can be embodied in software loaded in memory 204 and executed on processor 202. In some embodiments of the present invention, apparatus 200 is an appliance, such as appliance 190. In other embodiments of the present invention, apparatus 200 is a server, such as server 150.

Receiving mechanism 206 is configured to receive a collection of bids, wherein each bid in the collection includes an advertised performance criteria. Analysis mechanism 208 is configured to analyze a past performance history for a bidder associated with the bid. Furthermore, analysis mechanism 208 is also configured to analyze the past performance history for each bid in the collection of bids.

Determination mechanism 210 is configured to determine an expected performance criteria based on the analyzed past performance history, and the advertised performance criteria. Furthermore, determination mechanism 210 is also configured to determine the expected performance criteria for each bid in the collection of bids. Selection mechanism 212 is configured to select a winning bid from the collection of bids based on the expected performance criteria.

### Expected Performance Graph

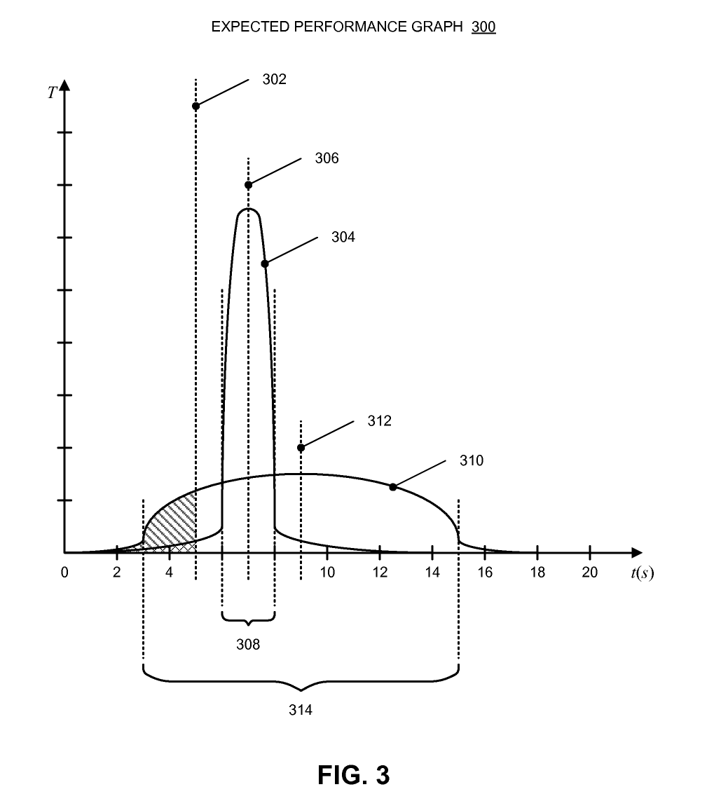

FIG. 3 illustrates expected performance graph 300 in accordance with an embodiment of the present invention. Expected performance graph 300 graphs the expected performance of two bids: a first bid represented by curve 304, and a second bid, represented by curve 310.

Using the previous example, the performance criterion for the organization is 5 seconds, as illustrated by dashed-line 302. Note that the horizontal axis, t(s), represents time in seconds, and the vertical axis, T, represents a number of transactions. Also consider that if the transaction takes longer than 5 seconds, it does not matter how long the transaction takes because it has failed to meet the organization's performance criterion. Thus, all transactions to the right of dashed-line 302 fail to meet the organization's criterion.

In this example, the organization receives two bids. The first bid (curve 304) has a mean of 7 seconds, which is illustrated by dashed-line 306. The first bid also has a standard deviation of +/−1 second, illustrated by the area between dashed-lines 308.

The second bid (curve 310) has a mean of 9 seconds, which is illustrated by dashed-line 312. The second bid also has a standard deviation of +/−6 seconds, illustrated by the area between dashed-lines 314.

While the first bid is much closer to the organization's criterion of 5 seconds, and the first bidder is more reliable, the second bid is actually the better choice for the organization.

In this example, the first bidder is reliable, but will also reliably fail the organization's criterion. If the first bid had a mean of 7 seconds, and a standard deviation of +/−1 second, the majority of the transactions for the first bidder will be in the 6 to 8 second range, all of which will fail for the organization. The distribution of successful transactions for the first bid is illustrated by the area under curve 304 and to the left of dashed-line 302, indicated by the double cross-hatching.

However, if the second bid has a mean of 9 seconds, and a standard deviation of +/−6 seconds, then the majority of the transactions for the second bidder will be in the 3 to 15 second range. Some transactions will be very late; however, some transactions will be in the 3 to 5 second range, and thus, satisfy the organization's criterion. The distribution of these successful transactions for the second bid is illustrated by the area under curve 310 and to the left of dashed-line 302, indicated by the single cross-hatching plus the double cross-hatching. It is easy to see from expected performance graph 300 that the distribution of successful transactions for the second bid is much greater than the distribution of successful transactions for the first bid. In this case, the second bidder provides an outside chance of success while the first bidder will reliably fail.

### Selecting Bids

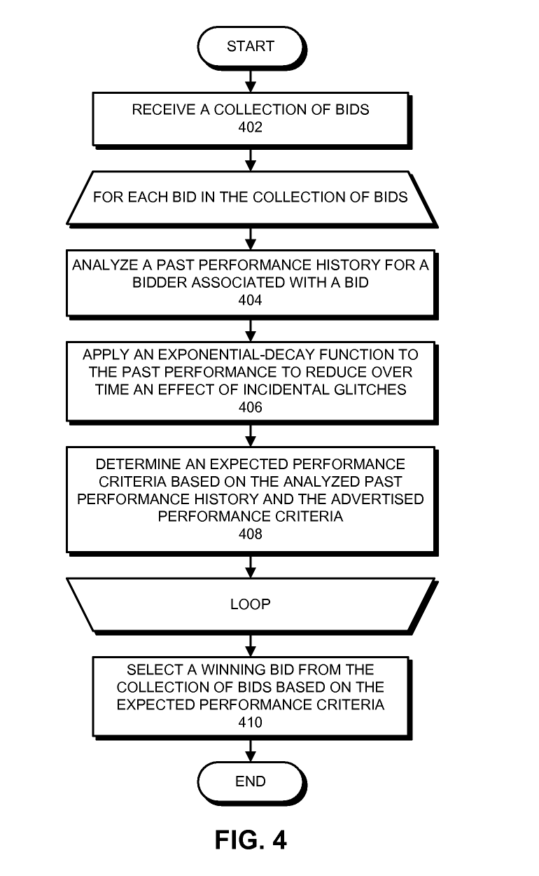

FIG. 4 presents a flow chart illustrating the process of selecting bids in accordance with an embodiment of the present invention.

During operation, the system receives a collection of bids (operation 402). Note that each bid in the collection of bids includes advertised performance criteria. For each bid in the collection of bids, the system analyzes a past performance history for a bidder associated with the bid (operation 404).

Note that in some embodiments of the present invention, the system analyzes the past performance by computing a mean value of the past performance history. The system also computes a standard deviation of the past performance history.

In some embodiments of the present invention, the system analyzes the past performance by applying an exponential-decay function to the past performance to reduce over time an effect of incidental glitches (operation 406).

Next, for each bid, the system determines an expected performance criteria based on the analyzed past performance history, and the advertised performance criteria (operation 408). Finally, the system selects a winning bid from the collection of bids based on the expected performance criteria (operation 410).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A computer-implemented method for selecting auction bids, the method comprising:
receiving a collection of bids, wherein each bid in the collection of bids includes an advertised performance criterion corresponding to an estimated transaction processing time;
for each given bid in the collection of bids:
analyzing, by a processor, a past performance history for a bidder associated with the given bid by computing a mean value of the past performance history and computing a standard deviation of the past performance history; and
determining, by the processor, an expected performance criterion based on a calculated difference between the past performance history and the advertised performance criterion including generating an expected performance graph of two bids, a first bid represented by a first curve and a second bid represented by a second curve, wherein an area under each respective curve represents a distribution of successful transactions for a respective bid; and
selecting a winning bid from the collection of bids based on the expected performance criterion including evaluating the expected performance graph,
wherein selecting the winning bid includes selecting a first bid having a first mean expected performance criterion that is further from a pre-specified target performance criterion than a second mean expected performance criterion of a second bid based on the first bid having a higher standard deviation than the second bid.

2. (canceled)

3. The method of claim 1, wherein analyzing the past performance history involves applying an exponential-decay function to the past performance history to reduce over time an effect of incidental glitches.

4. The method of claim 1, wherein determining the expected performance criterion involves performing a Monte Carlo simulation, which determines performance based on a range of values for past performance history and advertised performance criterion.

5. The method of claim 1, further comprising storing the past performance history in a database to facilitate subsequent analysis.

6. The method of claim 1, further comprising:
generating a graph of the past performance history; and
storing the graph to facilitate subsequent analysis.

7-8. (canceled)

9. A computer-readable storage medium storing instructions that when executed by a computer cause the computer to perform a method for selecting auction bids, the method comprising:
receiving a collection of bids, wherein each bid in the collection of bids includes an advertised performance criterion corresponding to an estimated transaction processing time;
for each given bid in the collection of bids:
analyzing a past performance history for a bidder associated with the given bid by computing a mean value of the past performance history and computing a standard deviation of the past performance history;
and
determining an expected performance criterion based on a calculated difference between the past performance history and the advertised performance criterion including generating an expected performance graph of two bids, a first bid represented by a first curve and a second bid represented by a second curve, wherein an area under each respective curve represents a distribution of successful transactions for a respective bid; and
selecting a winning bid from the collection of bids based on the expected performance criterion including evaluating the expected performance graph;
wherein selecting the winning bid includes selecting a first bid having a mean expected performance criterion that is further from a pre-specified target performance criterion than a second mean expected performance criterion of a second bid based on the first bid having a higher standard deviation than the second bid.

10. (canceled)

11. The computer-readable storage medium of claim 9, wherein analyzing the past performance history involves applying an exponential-decay function to the past performance history to reduce over time an effect of incidental glitches.

12. The computer-readable storage medium of claim 9, wherein determining the expected performance criterion involves performing a Monte Carlo simulation, which determines performance based on a range of values for past performance history and advertised performance criterion.

13. The computer-readable storage medium of claim 9, further comprising storing the past performance history in a database to facilitate subsequent analysis.

14. The computer-readable storage medium of claim 9, further comprising:
generating a graph of the past performance history; and
storing the graph to facilitate subsequent analysis.

15-16. (canceled)

17. An apparatus comprising:
a memory that stores processor-executable instructions for selecting auction bids; and
a processor, coupled to the memory, that executes the processor-executable instructions to:
receive a collection of bids, wherein each bid in the collection of bids includes an advertised performance criterion corresponding to an estimated transaction processing time;
analyze a past performance history for a bidder associated with the bid, wherein the analysis mechanism is further configured to analyze the past performance history for each given bid in the collection of bids by computing a mean value of the past performance history and computing a standard deviation of the past performance history;
determine an expected performance criterion based on a calculated difference between the past performance history and the advertised performance criterion including generating an expected performance graph of two bids, a first bid represented by a first curve and a second bid represented by a second curve, wherein an area under each respective curve represents a distribution of successful transactions for a respective bid, wherein the determination mechanism is further configured to determine the expected performance criterion for each given bid in the collection of bids; and
select a winning bid from the collection of bids based on the expected performance criterion including evaluating the expected performance graph, wherein selecting the winning bid includes selecting a first bid having a mean expected performance criterion that is further from a pre-specified target performance criterion than a second mean expected performance criterion of a second bid based on the first bid having a higher standard deviation than the second bid.

18. (canceled)

19. The method of claim 17, wherein the instruction to analyze the past performance history is further configured to apply an exponential-decay function to the past performance history to reduce over time an effect of incidental glitches.

20. The method of claim 17, wherein the instruction to determine the expected performance criterion is further configured to perform a Monte Carlo simulation, which determines performance based on a range of values for past performance history and advertised performance criterion.
